(19) United States
(12) Patent Application Publication
(10) Pub. No.: US 2023/0032662 A1
(43) Pub. Date: Feb. 2, 2023

(54) METAL COMPOSITE MATERIAL AND METHOD FOR PRODUCING METAL COMPOSITE MATERIAL

(71) Applicant: KABUSHIKI KAISHA KOBE SEIKO SHO (KOBE STEEL, LTD.), Kobe-shi (JP)

(72) Inventors: Yoshihaya IMAMURA, Kanagawa (JP); Chieko IMAI, Kanagawa (JP)

(73) Assignee: KABUSHIKI KAISHA KOBE SEIKO SHO (KOBE STEEL, LTD.), Kobe-shi (JP)

(21) Appl. No.: 17/789,074

(22) PCT Filed: Dec. 18, 2020
(86) PCT No.: PCT/JP2020/047576

§ 371 Date: Jun. 24, 2022

(30) Foreign Application Priority Data
Dec. 26, 2019 (JP) 2019-236720

(51) Int. Cl. B22D 21/04; C22C 21/00

(52) U.S. Cl. CPC B22D 21/04; C22C 21/00

(57) ABSTRACT

Provided are: a metal composite material in which a metal material and an aluminum casting are integrated with one another so as to exhibit high adhesion strength; and a method for producing the same. The metal composite material has a metal material and an aluminum casting which is layered on the metal material. Projecting alloy sections of the metal material which have a higher melting point than does the aluminum casting are formed on the surface of the metal material. The aluminum casting covers the surface of the metal material and is tightly adhered to the projecting alloy sections.

### TECHNICAL FIELD

The present invention relates to a metal composite material and a method for producing the metal composite material.

### BACKGROUND ART

As a technique of producing a cast aluminum product in which a metal material is inserted, for example, Patent Literature 1 discloses a method of producing a caliper body in which a metal pipe made of aluminum is subjected to insert casting with cast aluminum. According to this production method, the metal pipe is set in a mold, and the molten aluminum alloy is poured into a cavity of the mold, and as a result, the caliper body in which the metal pipe has been inserted by casting is obtained.

### CITATION LIST

### Patent Literature

Patent Literature 1: JP 2000-97262 A

### SUMMARY OF INVENTION

### Technical Problem

However, when the molten aluminum alloy is simply poured into spaces around a metal material such as a metal pipe to integrate the metal material and the cast aluminum portion, the adhesion force between the metal material and the cast aluminum portion may be insufficient, and necessary strength may not be obtained. In particular, in the case of producing a structural member having high strength, it is necessary to join a metal material and cast aluminum to each other with high strength, and therefore, it is required to further improve the adhesion force between the metal material and the cast aluminum.

Accordingly, an object of the present invention is to provide a metal composite material in which a metal material and cast aluminum are integrated with high adhesion strength, and a method for producing the metal composite material.

### Solution to Problem

The present invention includes the following constitutions.

(1) A metal composite material comprising a metal material and cast aluminum stacked on the metal material,

wherein an alloy protrusion based on the metal material is formed on a surface of the metal material, the alloy protrusion having a melting point higher than that of the cast aluminum, and the cast aluminum adheres to the alloy protrusion and covers the surface of the metal material.

(2) A method for producing a metal composite material in which a metal material and cast aluminum are stacked, the method comprising:

a powder arrangement step of arranging a powder on a surface of the metal material, the powder having a melting point higher than that of the cast aluminum;

an alloy protrusion forming step of melting and alloying the powder and the metal material on the surface of the metal material, and forming an alloy protrusion that protrudes from the surface of the metal material; and

a casting step of pouring molten aluminum onto the surface of the metal material on which the alloy protrusion has been formed and solidifying the molten aluminum, and stacking the metal material and the cast aluminum.

### Advantageous Effects of Invention

In the present invention, a metal material and cast aluminum can be integrated with high adhesion strength.

### BRIEF DESCRIPTION OF DRAWINGS

FIG. 1 is a schematic cross-sectional view of a structure of a metal composite material.

FIG. 2 is a partially enlarged schematic cross-sectional view of an alloy protrusion formed on a surface of a metal material.

FIG. 3 is a process explanatory diagram schematically showing a state in which the alloy protrusions are formed on the metal material by laser cladding.

FIG. 4 is a schematic cross-sectional view of the metal material on which the alloy protrusions are formed.

FIG. 5 is a schematic diagram showing a state in which the alloy protrusions are formed by laser cladding.

FIG. 6A is a process explanatory diagram of a casting process, and is a schematic cross-sectional view illustrating a state in which a pair of metal materials facing each other is arranged.

FIG. 6B is a process explanatory diagram of the casting process, and is a schematic cross-sectional view illustrating a state in which molten aluminum is poured into a space between the pair of metal materials.

FIG. 7A is a schematic perspective view of a metal material when laser cladding is performed on the metal material in a single scanning path.

FIG. 7B is a schematic perspective view of a metal material when laser cladding is performed on the metal material in multiple scanning paths.

FIG. 8 is a plan view of a metal composite material in Example 1.

FIG. 9 is a schematic perspective view illustrating a state in which a pair of metal materials that faces each other is arranged in Example 1.

FIG. 10 is a plan view of a metal composite material in Comparative Example 2.

FIG. 11 is a partial cross-sectional view taken along a line XI-XI shown in FIG. 10.

FIG. 12 is a graph showing a result of a shearing test of the metal composite materials.

FIG. 13 is a schematic illustration view of a cross section of a joint interface between a wrought aluminum alloy and cast aluminum in the metal composite material in Example 1.

### DESCRIPTION OF EMBODIMENTS

Hereinafter, embodiments of a metal composite material in the present invention are described in detail with reference to the drawings.

### <Metal Composite Material>

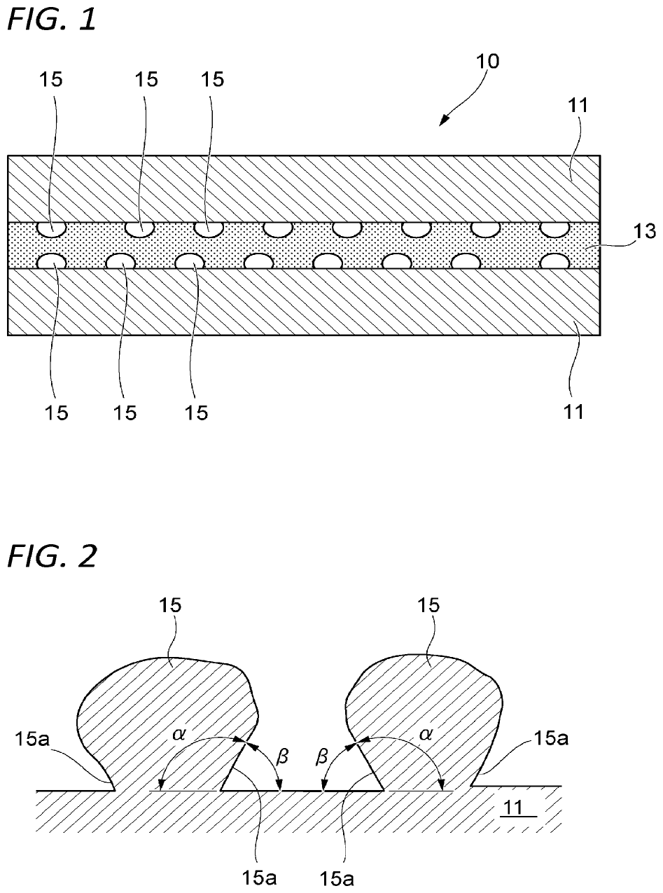

FIG. 1 is a schematic cross-sectional view of a structure of a metal composite material.

In a metal composite material 10, metal materials 11 and cast aluminum 13 are stacked. The present configuration example provides a structure in which a layer of the cast aluminum 13 is provided between a pair of metal materials 11 formed in a plate shape, and the pair of metal materials 11 and the cast aluminum 13 are integrally joined. Alloy protrusions 15 that protrude outward (toward the cast aluminum 13 side) are formed on a surface of the metal material 11 on the cast aluminum 13 side. The alloy protrusions 15 are formed in a state in which a powder containing metal and a surface layer portion of the metal material 11 are melted and alloyed. Depending on the amount or kind of the powder, the alloyed protrusion may be completely dissolved in the metal material 11, or a compound may be precipitated when the alloyed protrusion cannot be dissolved in the metal material 11. The cast aluminum 13 adheres to an outer surface of the alloy protrusions 15 and covers the surface of the metal material 11.

For example, a wrought aluminum alloy can be used as the metal material 11. The wrought aluminum alloy may be a wrought material of 2000 series aluminum alloy, 3000 series aluminum alloy, 4000 series aluminum alloy, 5000 series aluminum alloy, 6000 series aluminum alloy, or 7000 series aluminum alloy, or a wrought material of 1000 series pure aluminum. The metal material 11 is not limited to a plate material, and may be an extruded profile (a pipe material, or a hollow, solid, or irregular cross-sectional profile) or a forged material (a plate material, or a ribbed material). Further, the surface of the metal material 11 may be subjected to various surface treatments such as a blast treatment, an etching treatment, and a brush polishing treatment, as a preliminary treatment. In this case, an organic substance on the surface of the metal material 11 is removed, and the joining quality between the metal material 11 and the cast aluminum 13 is improved. As the metal material 11, in addition to the aluminum material, other light metals such as magnesium, or an iron-based material such as a high-tensile steel plate may be used depending on conditions.

Examples of materials of the cast aluminum 13 include AC4C, AC4CH, AC2B (JIS H 5202), and ADC12 (JIS H 5302).

FIG. 2 is a partially enlarged schematic cross-sectional view of the alloy protrusions 15 formed on the surface of the metal material 11.

The alloy protrusions 15 are formed on the surface of the metal material 11 by melting and alloying the metal material 11 with a powder having a melting point higher than that of the cast aluminum 13. Examples of the powder include a titanium metal powder, a powder of a titanium compound such as a titanium aluminum alloy, an aluminum metal powder that is the same as the metal material 11, and a powder obtained by appropriately mixing these powders. For example, a powder obtained by mixing an aluminum metal powder that is the same as the metal material 11, a boron carbide powder, and a titanium metal powder can be used. The grain diameter of the powder is preferably 1 μm to 100 μm.

It is preferable that the wettability of the powder with the metal material 11 is low, and a contact angle of the powder is large. As a method of heating the powder, heating using laser beam irradiation is preferred from the viewpoint of running cost and reduction in damage to the metal material 11. In addition, it is also possible to use a technique of plasma powder overlay welding using an arc as a heat source.

When the powder is titanium or a titanium compound, the alloy protrusion 15 is firmly joined to the metal material 11 via a titanium-based intermetallic compound between the alloy protrusion 15 and the metal material 11. The alloy protrusion 15 has low wettability with the wrought aluminum alloy, so that a contact angle α between the alloy protrusion 15 and the metal material 11 is an obtuse angle.

Therefore, a biting portion 15a having an overhanging cross-sectional shape is formed on a base end side of the alloy protrusion portion 15 to be joined to the metal material 11. In the biting portion 15a, a biting angle β (β=180−α) between the surface of the alloy protrusion 15 and the surface of the metal material 11 is an acute angle, and as shown in FIG. 1, the molten aluminum enters the biting portion 15a and the biting portion 15a is filled with the cast aluminum 13. Therefore, an anchor effect is exerted between the metal material 11 and the cast aluminum 13, and the metal material 11 and the cast aluminum 13 are joined to each other with higher adhesion strength.

In particular, at a location where the alloy protrusions 15 are adjacent to each other, the cast aluminum 13 enters a space between the alloy protrusions 15, and the adjacent alloy protrusions 15 lock the cast aluminum 13. Accordingly, the metal material 11 and the cast aluminum 13 are firmly joined to each other.

The alloy protrusion 15 is formed of a porous body, and a large number of recessed portions are formed on the surface of the alloy protrusion 15. When the molten aluminum enters the recessed portions of these surfaces, the joining between the cast aluminum 13 and the alloy protrusions 15 becomes stronger.

As described above, the metal composite material 10 with the present configuration has a structure in which the cast aluminum 13 stacked on the metal material 11 covers the alloy protrusions 15 formed on the surface of the metal material 11 and adheres to the metal material 11, and therefore, the adhesion strength between the metal material 11 and the cast aluminum 13 in the metal composite material 10 is increased.

Even when an aluminum material is used as the metal material 11, a material is selected such that the melting point of the metal material 11 is higher than the melting point of the cast aluminum 13. Accordingly, when molten aluminum is poured into the metal material 11 on which the alloy protrusions 15 are formed, the metal material 11 is not melted by heat from the molten aluminum, and the alloy protrusions 15 are not separated from the metal material 11.

### <Method of Producing Metal Composite Material>

Next, a method of producing the metal composite material 10 having the above-described configuration is described.

Here, a process of forming the alloy protrusions 15 on the metal material 11 by laser cladding is described, but the method of forming the alloy protrusions 15 is not limited to this example.

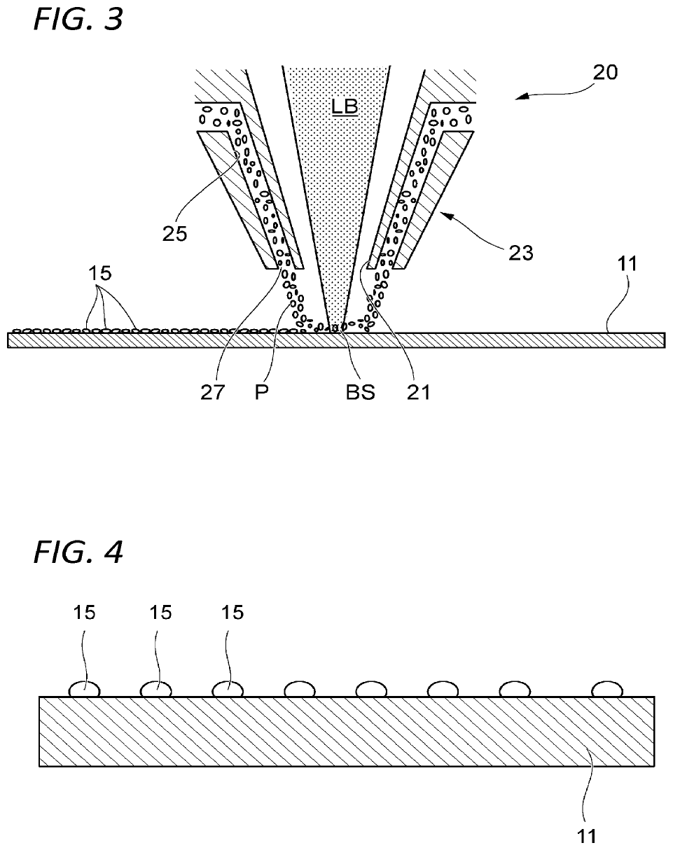

FIG. 3 is a process explanatory diagram schematically showing a state in which the alloy protrusions 15 are formed on the metal material 11 by laser cladding.

In the laser cladding, first, a powder for forming the alloy protrusions 15 is arranged on the surface of the metal material 11 (powder arrangement step). Thereafter, the powder arranged on the surface of the metal material 11 is melted together with the metal material 11 by laser beam irradiation to form the alloy protrusions 15 (alloy protrusion forming step). In the laser cladding apparatus capable of continuously supplying the powder, the powder arrangement step and the alloy protrusion forming step are simultaneously performed while moving from one place to another place.

The laser cladding apparatus includes a laser processing head 20 whose position and posture can be changed by a robot (not shown). The laser processing head 20 includes a nozzle 23 that has an irradiation port 21 at a central portion, a laser output unit (not shown) that outputs laser beam LB, and a powder supply unit (not shown) that supplies powder to the nozzle 23. The laser processing head 20 is disposed such that the nozzle 23 faces a position where the alloy protrusions 15 are to be formed on the surface of the metal material 11.

The metal material 11 is irradiated with the laser beam LB that is output from the laser output unit and is condensed by passing through the irradiation port 21 of the nozzle 23. A powder supply path 25 through which the powder is supplied to an irradiation position of the laser beam LB is formed on an outer periphery of the irradiation port 21 of the nozzle 23. A powder P is supplied to the powder supply path 25 from the powder supply unit (not shown). The powder P supplied to the powder supply path 25 is supplied to a beam spot BS, which is the irradiation position of the laser beam LB, from a powder supply port 27 of the nozzle 23, the powder supply port 27 being opened downward. Although not shown, a gas supply path is provided in the nozzle 23, and an assist gas such as a nitrogen gas is blown toward the beam spot BS of the laser beam LB through the gas supply path.

When the alloy protrusions 15 are formed by using the laser cladding apparatus having the above configuration, the metal material 11 is arranged such that the surface on which the alloy protrusions 15 are formed faces upward, and the nozzle 23 is brought close to the metal material 11 from above. Then, while the powder P is supplied through the powder supply port 27 of the nozzle 23, irradiation with the laser beam LB through the nozzle 23 is performed, and the nozzle 23 is moved at a preset scanning speed. At this time, the assist gas is blown to the beam spot BS of the laser beam LB.

As the laser beam LB, for example, a semiconductor laser beam having a wavelength of 970 nm may be used, and the beam diameter at the beam spot BS may be 1 to 1.2 mm, and in particular, the beam diameter is desirably 0.5 mm or less, preferably 0.3 mm or less, and more preferably 0.2 mm or less in order to reduce the size of the alloy protrusions. From the viewpoint of processing time and productivity, the beam diameter at the beam spot BS is preferably 0.1 mm or more.

It is preferable that the scanning speed of the laser beam LB is appropriately set within a range of, for example, 30 mm/s to 100 mm/s according to the shapes and the number of the alloy protrusions 15 to be formed. The output of the laser beam LB is preferably about 100 W to 400 W, for example. The laser beam LB is not limited to a semiconductor laser as long as the metal powder can be melted by heating the powder P, and may be a fiber laser, an Nd:YAG laser, a carbon dioxide laser, or the like.

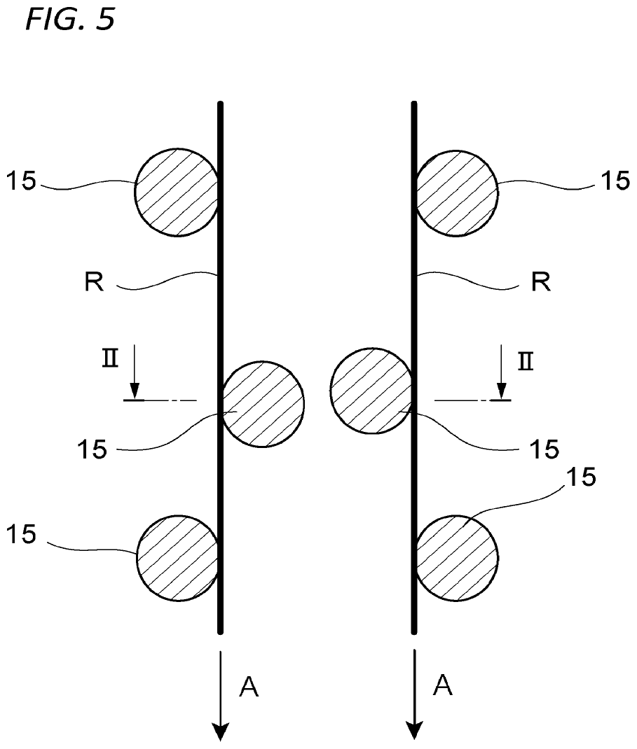

FIG. 4 is a schematic cross-sectional view of the metal material 11 on which the alloy protrusions 15 are formed. FIG. 5 is a schematic diagram showing a state in which the alloy protrusions 15 are formed by laser cladding.

As described above, when the laser cladding is performed on the surface of the metal material 11, the powder and the metal material 11 are melted and alloyed by the laser beam LB on the surface of the metal material 11, and a mass of a porous body including an intermetallic compound and a cavity is formed by protruding from the surface of the metal material 11. In the alloy protrusions 15 shown in FIG. 2, the contact angle α is an obtuse angle.

At this time, as shown in FIG. 5, most of the alloy protrusions 15 are formed on both sides of a scanning path R of the laser beam LB scanned in one direction (arrow A direction). The laser cladding toward the surface of the metal material 11 is preferably repeated a plurality of times along the scanning paths R spaced from each other. By forming the scanning paths R in a plurality of rows, the arrangement density of the alloy protrusions 15 is improved, and the alloy protrusions 15 formed in the respective scanning paths R are arranged adjacent to each other. Accordingly, the anchor effect is enhanced. Here, FIG. 2 described above is a schematic cross-sectional view of the alloy protrusions 15 arranged adjacent to each other, corresponding to the cross section taken along a line II-II in FIG. 5.

The pair of metal materials 11 having the alloy protrusions 15 formed on the surfaces thereof as described above are joined to each other via the cast aluminum 13.

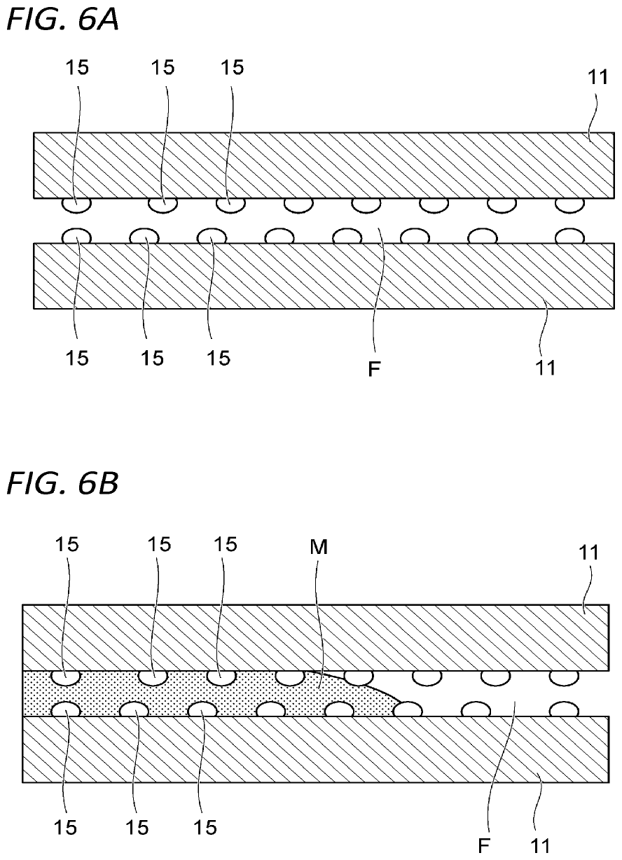

FIG. 6A is a process explanatory diagram of a casting process, and is a schematic cross-sectional view illustrating a state in which a pair of metal materials 11 face each other is arranged. FIG. 6B is a process explanatory diagram of the casting process, and is a schematic cross-sectional view illustrating a state in which molten aluminum is poured into a space between the pair of metal materials 11.

As shown in FIG. 6A, the pair of metal materials 11 are arranged such that the surfaces on which the alloy protrusions 15 are formed face each other with a predetermined gap therebetween. Accordingly, a flow path F through which the molten aluminum flows is formed between the metal materials 11.

Next, as shown in FIG. 6B, a molten aluminum M is poured into the flow path F. Since the alloy protrusions 15 include the powder P having a melting point higher than that of the cast aluminum 13, the alloy protrusions 15 are not melted by the heat of the molten aluminum M even when the molten aluminum M passes through the alloy protrusions 15. Therefore, even during the time when the molten aluminum M is poured, the alloy protrusions 15 are maintained in a state of being fixed to the surface of the metal material 11. Then, the molten aluminum M enters the space between the alloy protrusions 15 formed on the surface of the metal material 11 without a gap.

Thereafter, the molten aluminum M poured into the flow path F is cooled and solidified, and the surface of the metal material 11 is covered with the cast aluminum 13 in a state of adhering to the alloy protrusions 15. In this way, the metal composite material 10 (see FIG. 1) in which the pair of metal materials 11 and the cast aluminum 13 are stacked is obtained.

Thanks to the method of producing the metal composite material, the metal composite material 10 in which the surface of the metal material 11 is covered with the cast aluminum 13 in a state in which the alloy protrusions 15 provided on the metal material 11 adhere to the cast aluminum 13 is obtained. Thanks to the metal composite material 10, the adhesion strength between the metal material 11 and the cast aluminum 13 is improved, and the tensile strength, the shear strength, and the bending strength are increased as compared with the case where the alloy protrusions 15 are not provided.

The formation of the alloy protrusions 15 on the metal material 11 can be performed by a dry process, so that the alloy protrusions 15 can be easily formed at any position in a short time without a complicated process as compared with a wet process using dedicated equipment. The alloy protrusions 15 can be formed with such high workability, so that the alloy protrusions 15 can be arranged as much as necessary in a portion where the joining strength with the cast aluminum 13 is particularly required, and the degree of freedom in design of the metal composite material 10 can be improved. Therefore, the present production method can be suitably applied to the production of various casting products, and the metal composite material 10 can be produced with high quality and at low cost.

In addition, the powder is melted on the surface of the metal material 11 and the metal material 11 and the powder are alloyed by laser cladding, and as a result, a large number of alloy protrusions 15 can be efficiently formed. That is, the laser processing head 20 and the metal material 11 are relatively moved, and the surface of the metal material 11 is irradiated with the laser beam LB while supplying the powder P to the surface of the metal material 11, and as a result, the powder P can be continuously alloyed on the surface of the metal material 11. Accordingly, the alloy protrusions 15 can be formed in a short time over a wide range of the metal material 11.

Then, as shown in FIG. 5, the surface of the metal material 11 is irradiated with the laser beam LB a plurality of times while the irradiation position is shifted, and as a result, a large number of alloy protrusions 15 are formed, and the adhesion strength between the metal material 11 and the cast aluminum 13 is increased.

In particular, as the beam diameter of the laser beam LB with which the surface of the metal material 11 is irradiated is reduced to a small diameter of 0.5 mm or less, the contact angle α (see FIG. 2) between the metal material 11 and the alloy protrusion 15 formed on the metal material 11 tends to increase. Accordingly, the biting angle β to the cast aluminum 13 on the outer side of the alloy protrusion 15 is reduced, and the adhesion strength with the cast aluminum 13 is further increased.

In the above production method, the step of arranging the powder P on the surface of the metal material 11 by the laser cladding apparatus (powder arrangement step) and the step of melting the powder P to form the alloy protrusions 15 together with the metal material 11 (alloy protrusion forming step) are performed simultaneously, and these steps may be performed separately. Specifically, the powder P may be arranged on the metal material 11 by being sprayed on the surface of the metal material 11 or being mixed with an appropriate solvent and applied to the surface of the metal material 11, and then the powder P may be melted by irradiating the surface of the metal material 11 on which the powder P is arranged with the laser beam LB, and thus, the alloy protrusions 15 may be formed on the surface of the metal material 11.

In addition, the metal composite material 10 described above has a configuration in which the cast aluminum 13 is stacked in the space between a pair of metal materials 11, but the present invention is not limited to this example. The metal composite material 10 may be a metal composite material in which the cast aluminum 13 is stacked on one metal material 11. Furthermore, the metal material 11 is not limited to a plate material as described above, and may be a pipe material. For example, the alloy protrusions 15 are formed on an outer peripheral surface of a cylindrical cylinder liner (metal material 11), and molten aluminum is poured into the outer periphery of the cylinder liner, and as a result, the cylinder liner and the cast aluminum 13 may be integrally formed. Such a metal composite material can be suitably applied to, for example, an engine block.

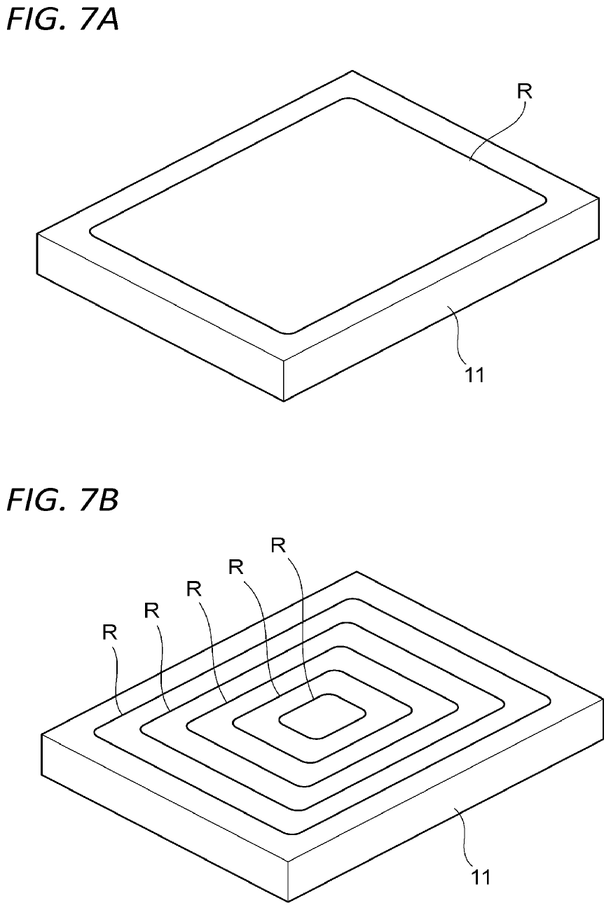

FIG. 7A is a schematic perspective view of the metal material 11 when laser cladding is performed on the metal material 11 in a single scanning path. FIG. 7B is a schematic perspective view of the metal material 11 when laser cladding is performed on the metal material 11 in multiple scanning paths.

The laser cladding applied to the metal material 11 may be performed along a single rectangular scanning path R that is along an outer edge of the metal material 11 as shown in FIG. 7A, or may be performed along a plurality of rectangular scanning paths R arranged concentrically from the center of the metal material 11 toward the outer edge as shown in FIG. 7B. The scanning path R may be circular. In this case, high-speed scanning can be performed with simple control.

When the scanning path R is formed along the outer edge of the metal material 11, the laser cladding can be continuously performed along the long scanning path R, so that a large number of alloy protrusions 15 can be efficiently formed in a short time. Further, the laser cladding is performed along the plurality of scanning paths R, and as a result, the alloy protrusions 15 can be arranged over a wide area of the metal material 11. Each of the scanning paths R illustrated in FIG. 7A and FIG. 7B may include a plurality of rows of scanning paths R separated from each other by a minute distance as illustrated in FIG. 5. For example, laser cladding is performed along double or triple scanning paths R that are along the outer edge of the metal material 11, so that it is possible to form the alloy protrusions 15 at a higher density while preventing an increase in processing time. The minute distance is, for example, 1 mm or less, preferably 0.8 mm or less, and more preferably 0.5 mm or less.

### EXAMPLES

Molten aluminum was poured into a space between two flat plate-shaped metal materials, and the poured molten aluminum was solidified, thereby producing a metal composite material in which the metal materials were joined to each other by cast aluminum. The metal materials of the produced metal composite material were pulled in a surface direction of the metal material, and a shear load at a joint location was measured.

### Metal Composite Material

### Example 1

### (1) Metal Material

Two wrought aluminum alloys (6000 series) having a length L of 110 mm, a width W of 30 mm, and a thickness of 2 mm

### (2) Cast Aluminum

Aluminum Alloy (ADC12)

### (3) Powder

Titanium Compound

### (4) Production of Metal Composite Material

As shown in FIG. 8, laser cladding was performed on a surface of one end portion of each of two metal materials formed in a rectangular shape. The laser cladding was performed by scanning along a rectangular scanning path R having a side of about 25 mm while simultaneously performing the supply of the powder and the irradiation with the laser beam. The scanning path R is double paths separated from each other by a minute distance, and laser cladding was performed by scanning twice along the scanning path R. Accordingly, alloy protrusions obtained by melting and alloying the powder were formed on the surface of one end portion of the metal material.

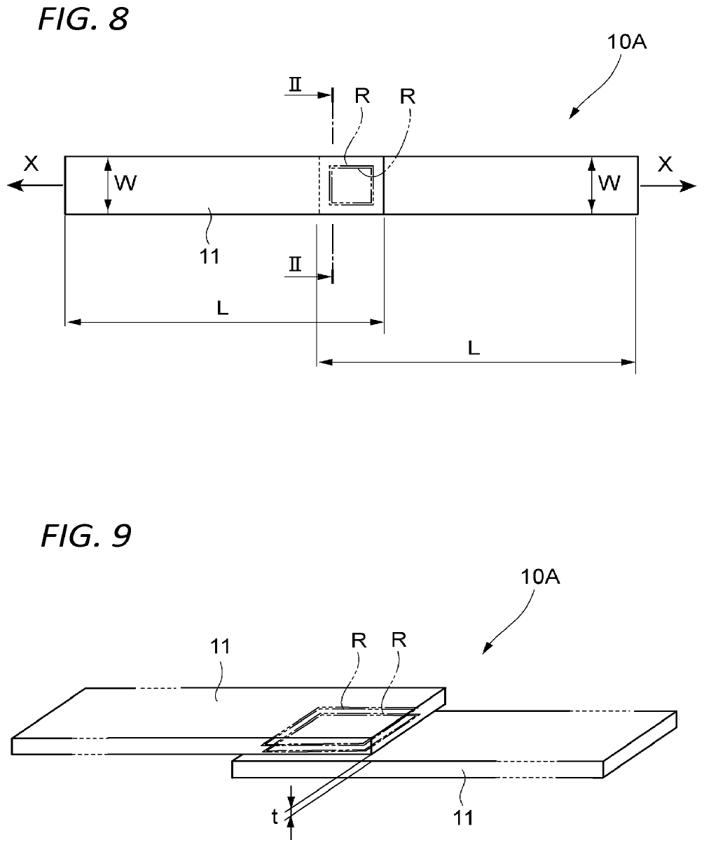

As shown in FIG. 9, the surfaces of the two metal materials, on which the alloy protrusions were formed, faced each other with a gap of 1 mm therebetween, and the two metal materials were disposed so as to overlap with each other for 30 mm from an end surface of one end portion. Molten aluminum of cast aluminum was poured into the gap between the metal materials to form cast aluminum, thereby producing a metal composite material.

### Comparative Example 1

### (1) Metal Material

Two wrought aluminum alloys (6000 series) having a length L of 110 mm, a width W of 30 mm, and a thickness of 2 mm

### (2) Cast Aluminum

Aluminum Alloy (ADC12)

### (3) Production of Metal Composite Material

A metal composite material was produced in the same manner as in Example 1 except that the laser cladding in Example 1 was omitted.

### Comparative Example 2

### (1) Metal Material

Two wrought aluminum alloys (6000 series) having a length L of 110 mm, a width W of 30 mm, and a thickness of 2 mm

### (2) Cast Aluminum

Aluminum Alloy (ADC12)

### (3) Production of Metal Composite Material

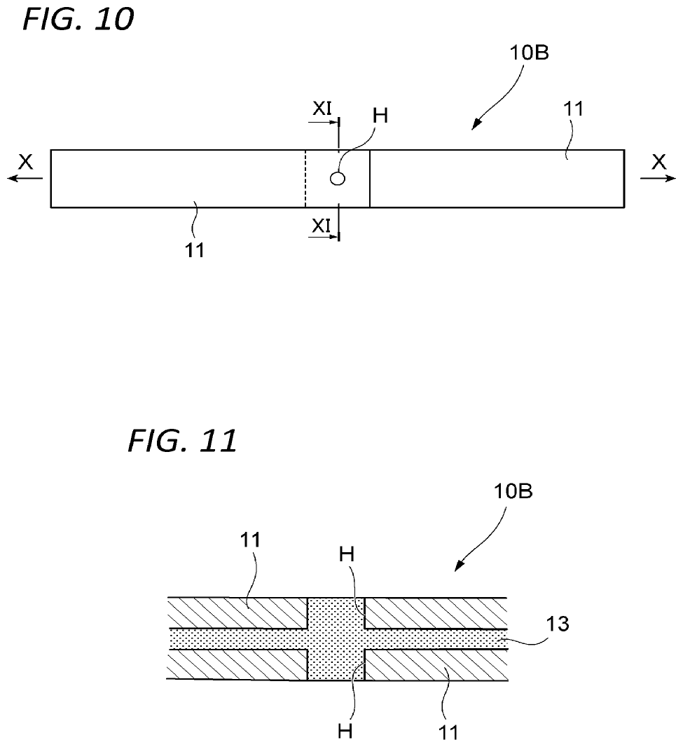

As shown in FIG. 10, a through hole H having a diameter of 5 mm was formed in one end portion of each of two wrought aluminum alloys formed in a rectangular shape.

Then, one end portions of the two wrought aluminum alloys faced each other with a gap of 1 mm therebetween, and the two wrought aluminum alloys were disposed so as to overlap with each other for 30 mm from the end surface of the one end portion in the same manner as in Example 1. As shown in FIG. 11, molten aluminum was poured into the gap between the wrought aluminum alloys and the through hole H to form cast aluminum, thereby producing a metal composite material.

### <Test Method>

With respect to the produced metal composite materials in Example 1 and Comparative Examples 1 and 2, a pair of wrought aluminum alloys were pulled in the surface direction (the direction of the arrow X in FIG. 8 and FIG. 10), and a shear load when the wrought aluminum alloys were separated at the joint location was measured.

### <Test Results>

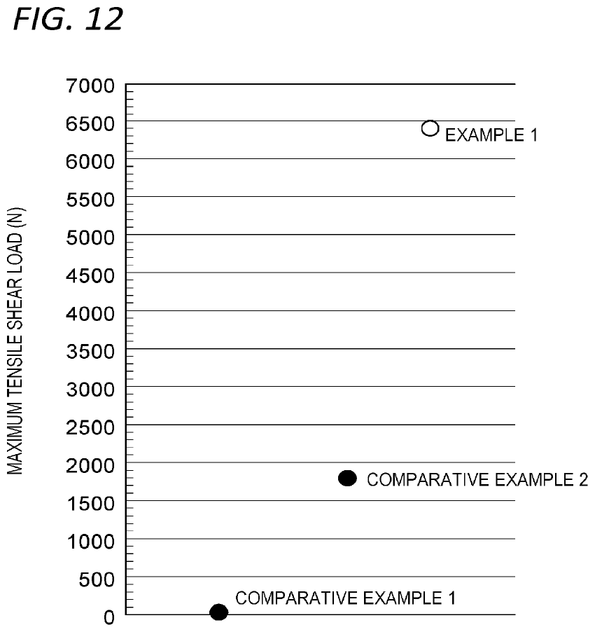

The results of the above test are shown in FIG. 12.

The metal composite material in Example 1 had a shear load of 6,400 N. In contrast, the shear load of the metal composite material in Comparative Example 1 was an extremely small value since the wrought aluminum alloys were separated at an initial stage of pulling. The metal composite material in Comparative Example 2 had a shear load of 1,800 N.

As described above, in the metal composite material in Example 1 in which the alloy protrusion is formed on the metal material and the molten aluminum is poured to form the cast aluminum, the shear load is significantly increased as compared with the metal composite material in Comparative Example 1 in which the alloy protrusion is not formed. As compared with the metal composite material in Comparative Example 2 in which the anchor of the cast aluminum was formed by forming the through hole in the metal material, a significant increase in the shear load was observed. The results of Example 1 are an average value of two metal composite materials produced under the same conditions, and the results of Comparative Examples 1 and 2 are an average value of five metal composite materials produced under the same conditions.

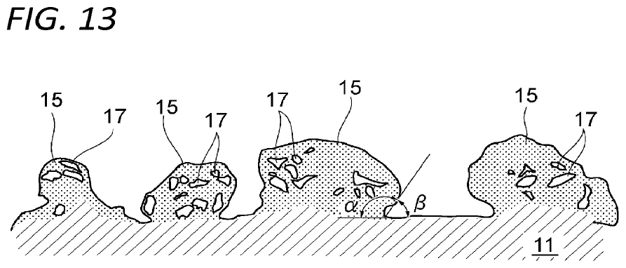

FIG. 13 is a schematic illustration view of a cross section of a joint interface between the wrought aluminum alloy and the cast aluminum in the metal composite material in Example 1.

The alloy protrusions 15 are formed on the surface of the wrought aluminum alloy (metal material 11). The cross-sectional shape of the alloy protrusion portion 15 on the base end side overhangs from a surface of the wrought aluminum alloy toward the cast aluminum side (upward in FIG. 13), and the contact angle α is an obtuse angle. The alloy protrusion 15 is a porous body in which a plurality of fine pores 17 are formed.

On the surface of the wrought aluminum alloy, fine irregularities caused by the alloy protrusions 15 are formed, and the molten aluminum flows into the irregularities, and as a result, the alloy protrusion 15 leads to a state of being engaged with the cast aluminum. In this way, a state in which the wrought aluminum alloy and the cast aluminum are joined to each other with high adhesion strength can be realized.

The present invention is not limited to the above embodiments, and combinations of the respective configurations of the embodiments, or changes and applications made by those skilled in the art based on the description and common technology are also intended by the present invention and are included within the scope to be protected.

As described above, the following matters are disclosed in the present description.

(1) A metal composite material comprising a metal material and cast aluminum stacked on the metal material,

wherein an alloy protrusion based on the metal material is formed on a surface of the metal material, the alloy protrusion having a melting point higher than that of the cast aluminum, and the cast aluminum adheres to the alloy protrusion and covers the surface of the metal material.

The metal composite material has a structure in which the cast aluminum stacked on the metal material adheres to the alloy protrusion formed on the surface of the metal material and covers the surface of the metal material, so that the adhesion strength between the metal material and the cast aluminum can be increased.

(2) The metal composite material according to (1), wherein a melting point of the metal material is higher than the melting point of the cast aluminum.

Thanks to the metal composite material, the metal material is not melted by the molten aluminum. Therefore, it is easy to maintain a state in which the alloy protrusion is formed on the metal material.

(3) The metal composite material according to (1) or (2), wherein the metal material is an aluminum material.

Thanks to the metal composite material, the aluminum materials can be joined to each other with increased adhesion strength by the alloy protrusion, and a metal composite material having high strength and light weight can be obtained.

(4) The metal composite material according to any one of (1) to (3), wherein the alloy protrusions are arranged on the surface of the metal material such that the alloy protrusions are dispersed and spaced from each other.

Thanks to the metal composite material, each of the dispersed alloy protrusions is covered with the cast aluminum, so that the adhesion strength between the metal material and the cast aluminum can be improved.

(5) The metal composite material according to any one of (1) to (4), wherein a contact angle between the alloy protrusion and the metal material is an obtuse angle.

Thanks to the metal composite material, the contact angle between the alloy protrusion and the metal material is an obtuse angle, so that the cast aluminum bites into the alloy protrusion with an acute angle on the surface of the metal material, and the joining strength between the alloy protrusion and the cast aluminum can be improved.

(6) The metal composite material according to any one of (1) to (5), wherein the alloy protrusion is a porous body having a large number of recessed portions formed on a surface thereof.

Thanks to the metal composite material, the molten aluminum enters the recessed portions of the surface of the alloy protrusion, and as a result, it is possible to further improve the adhesion strength between the alloy protrusion and the cast aluminum.

(7) A method for producing a metal composite material in which a metal material and cast aluminum are stacked, the method comprising:

a powder arrangement step of arranging a powder on a surface of the metal material, the powder having a melting point higher than that of the cast aluminum;

an alloy protrusion forming step of melting and alloying the powder and the metal material on the surface of the metal material, and forming an alloy protrusion that protrudes from the surface of the metal material; and

a casting step of pouring molten aluminum onto the surface of the metal material on which the alloy protrusion has been formed and solidifying the molten aluminum, and stacking the metal material and the cast aluminum.

Thanks to the method of producing the metal composite material in which the metal material and cast aluminum are stacked, the powder and the metal material are melted and alloyed on the surface of the metal material to form the alloy protrusions. The alloy protrusion is covered with the cast aluminum, so that the adhesion strength between the metal material and the cast aluminum is increased.

(8) The method for producing a metal composite material according to (7), wherein in the powder arrangement step and the alloy protrusion forming step, the alloy protrusion is formed by laser cladding in which while supplying the powder to the surface of the metal material, the powder supplied to the surface of the metal material is irradiated with laser beam.

Thanks to the method of producing the metal composite material, the alloy protrusions can be continuously formed by laser cladding with high efficiency.

(9) The method for producing a metal composite material according to (8), wherein when the alloy protrusion is formed on the surface of the metal material to which the powder has been supplied, irradiation with the laser beam is performed along at least two rows of scanning lines that are along an outer edge of a joint surface with the cast aluminum.

Thanks to the method of producing the metal composite material, a large number of alloy protrusions can be continuously formed along the outer edge of the joint surface with an increased arrangement density by irradiating at least two rows along the outer edge of the joint surface with laser beam. Accordingly, the adhesion strength between the metal material and the cast aluminum can be improved.

(10) The method for producing a metal composite material according to (8) or (9), wherein an irradiation beam diameter of the laser beam on the surface of the metal material is 0.5 mm or less.

Thanks to the method of producing the metal composite material, the contact angle of the alloy protrusion on the surface of the metal material is likely to be increased, and the biting angle into the cast aluminum on the outside of the alloy protrusion is small, so that the adhesion strength between the metal material and the cast aluminum is further increased.

The present application is based on Japanese Patent Application No. 2019-236720 filed on Dec. 26, 2019, the contents of which are incorporated by reference in the present application.

### REFERENCES SIGNS LIST

10 Metal composite material
11 Metal material
13 Cast aluminum
15 Alloy protrusion
LB Laser beam
M Molten aluminum
P Powder
α Contact angle

1. A metal composite material comprising a wrought aluminum alloy and cast aluminum stacked on the wrought aluminum alloy,
wherein an alloy protrusion based on the wrought aluminum alloy is formed on a surface of the wrought aluminum alloy, the alloy protrusion having a melting point higher than a melting point of the cast aluminum, and the cast aluminum adheres to the alloy protrusion and covers the surface of the wrought aluminum alloy.

2-4. (canceled)

5. The metal composite material according to claim 1, wherein the alloy protrusions are arranged on the surface of the wrought aluminum alloy such that the alloy protrusions are dispersed and spaced from each other.

6. The metal composite material according to claim 5, wherein a contact angle between the alloy protrusion and the wrought aluminum alloy is an obtuse angle.

7. (canceled)

8. The metal composite material according to claim 6, wherein the alloy protrusion is a porous body having a large number of recessed portions formed on a surface thereof.

9-15. (canceled)
